(19) United States
(12) Patent Application Publication
(10) Pub. No.: US 2008/0151095 A1
(43) Pub. Date: Jun. 26, 2008

(54) Image-capturing system and method

(75) Inventor: Hong-Long Chou, Taipei City (TW)

Correspondence Address: MCDERMOTT WILL & EMERY LLP, 18191 VON KARMAN AVE., SUITE 500, IRVINE, CA, 92612-7108, US

(73) Assignee: ALTEK CORPORATION, Hsinchu (TW)

(21) Appl. No.: 11/808,621

(22) Filed: Jun. 12, 2007

(30) Foreign Application Priority Data
Dec. 21, 2006 (TW) 095148277

(51) Int. Cl. H04N 5/222

(52) U.S. Cl. 348/333.11; 348/E05.022

(57) ABSTRACT

An image-capturing system and method analyze the darkest and brightest pixels indicated by an electrical signal to adjust the transmittance of each pixel of an optical element, so as to enhance the dynamic range of an image and to exhibit the details in bright and dark portions of the image. The image-capturing system includes an optical element, defining a plurality of pixels of controllable transmittance for modulating a received image; at least one lens for focusing the modulated image; an image sensor for transforming the focused image into an electrical signal; a processing unit for outputting a control signal, in response to the electrical signal, to respectively control the transmittance of each pixel of the optical element; and a storage unit, coupled with the processing unit, for storing an image information.

### CROSS-REFERENCE TO RELATED APPLICATION

This application claims priority from Taiwan Patent Application No. 095148277 filed Dec. 21, 2006, which is hereby incorporated herein by reference in its entirety.

### FIELD OF THE INVENTION

This invention relates to image-capturing systems and methods, and more particularly, to image-capturing systems and methods that can adjust the transmittance of each pixel of an optical element within the image-capturing system.

### BACKGROUND OF THE INVENTION

In currently existing image-capturing systems, pixels obtained during exposure are affected by the diaphragm size, camera shutter speed, and scene brightness. The diaphragm size and the camera shutter speed are the same for all pixels for one setting, but the scene brightness is different for different areas of the scene. If the brightness difference between different areas is too large, so called “high dynamic range”, the details may be lost in some areas which are either too dark or too bright. The dynamic range refers to the difference between the darkest and brightest portions of the image.

Regarding the above problems, a general known technique analyzes the brightness variation between adjacent pixels and adjusts the contrast by a rear-end software to exhibit the details in the dark and bright portions. In the area of image-capturing system, these techniques are called “contrast enhancement”, “tone reproduction”, and so on.

The drawback of the prior-art technique is that the enhancement of contrast between neighboring pixels may cause an image look discontinuity. Further, if the brightness values of the original pixel information are all underexposure, i.e., the minimum value the pixel can represent, or overexposure, i.e., the maximum value the pixel can represent, prior-art technique does not help. This is caused by the fact that the brightness change of the scene is wide and the image sensor is unable to respectively adjust the exposure amount of each pixel according to the brightness of each area during exposure.

### SUMMARY OF THE INVENTION

The first objective of the present invention is to provide an image-capturing system which analyzes the darkest and brightest pixels indicated by an electrical signal to adjust the transmittance of each pixel of an optical element, so as to enhance the dynamic range of an image and to exhibit the details in bright and dark portions of the image.

The second objective of the present invention is to provide an image-capturing method for an image-capturing system which includes an optical element defining a plurality of pixels of controllable transmittance. The method analyzes the darkest and brightest pixels indicated by an electrical signal to adjust the transmittance of each pixel of an optical element, so as to enhance the dynamic range of an image and to exhibit the details in bright and dark portions of the image.

In accordance with one aspect of the invention, there is provided an image-capturing system which includes an optical element, defining a plurality of pixels of controllable transmittance for modulating a received image; at least one lens for focusing the modulated image; an image sensor for transforming the focused image into an electrical signal; a processing unit for outputting a control signal, in response to the electrical signal, to respectively control the transmittance of each pixel of the optical element; and a storage unit, coupled with the processing unit, for storing an image information. In an exemplary embodiment, the optical element is a liquid crystal panel. In another exemplary embodiment, the image sensor includes a plurality of charge coupled devices (CCD) or a plurality of complementary metal-oxide semiconductors (CMOS). In another exemplary embodiment, the image-capturing system is one of digital camera, digital video camera, or camera cellular phone.

In accordance with another aspect of the invention, there is provided an image-capturing system which includes at least one lens for focusing a received image; an optical element, defining a plurality of pixels of controllable transmittance for modulating the focused image; an image sensor for transforming the modulated image into an electrical signal; a processing unit for outputting a control signal, in response to the electrical signal, to respectively control the transmittance of each pixel of the optical element; and a storage unit, coupled with the processing unit, for storing an image information. In an exemplary embodiment, the optical element is a liquid crystal panel. In another exemplary embodiment, the image sensor includes a plurality of charge coupled devices (CCD) or a plurality of complementary metal-oxide semiconductors (CMOS). In another exemplary embodiment, the image-capturing system is one of digital camera, digital video camera, or camera cellular phone.

In accordance with another aspect of the invention, there is provided an image-capturing method for an image-capturing system. The image-capturing system includes an optical element, defining a plurality of pixels of controllable transmittance. The image-capturing method includes the steps of: (a) receiving a first image of an object and modulating the first image by the optical element of a pre-selected transmittance; (b) focusing the modulated first image; (c) transforming the focused first image into a first electrical signal by an image sensor; (d) outputting a control signal, in response to the first electrical signal, to respectively adjust the transmittance of each pixel of the optical element; (e) receiving a second image of the same object and modulating the second image by the optical element of the adjusted transmittance; (f) focusing the modulated second image; (g) transforming the focused second image into a second electrical signal by the image sensor; and (h) storing the second electrical signal. In an exemplary embodiment, between steps (d) and (e), further includes: performing a fine adjustment step with respect to the transmittances of all pixels of the optical element. In another exemplary embodiment, in step (d), the control signal is determined based on analysis of the darkest and brightest pixels indicated by the first electrical signal.

In accordance with another aspect of the invention, there is provided an image-capturing method for an image-capturing system. The image-capturing system includes an optical element, defining a plurality of pixels of controllable transmittance. The image-capturing method includes the steps of: (a) receiving a first image of an object and focusing the received first image; (b) modulating the focused first image by the optical element of a pre-selected transmittance; (c) transforming the modulated first image into a first electrical signal by an image sensor; (d) outputting a control signal, in response to the first electrical signal, to respectively adjust the transmittance of each pixel of the optical element; (e) receiving a second image of the same object and focusing the received second image; (f) modulating the focused second image by the optical element of the adjusted transmittance; (g) transforming the modulated second image into a second electrical signal by the image sensor; and (h) storing the second electrical signal. In an exemplary embodiment, between steps (d) and (e), further includes: performing a fine adjustment step with respect to the transmittances of all pixels of the optical element. In another exemplary embodiment, in step (d), the control signal is determined based on analysis of the darkest and brightest pixels indicated by the first electrical signal.

### BRIEF DESCRIPTION OF DRAWINGS

The foregoing and advantages of the invention will be appreciated more fully from the following further description thereof with reference to the accompanying drawings wherein:

FIG. 1 shows an image-capturing system 10 according to a preferred embodiment of the present invention.

FIG. 2 shows an image-capturing system 20 according to another preferred embodiment of the present invention.

FIG. 3 shows a flow chart of an image-capturing method according to a preferred embodiment of the present invention.

FIG. 4 shows a flow chart of an image-capturing method according to another preferred embodiment of the present invention.

FIG. 5 shows an example of the pixels of an optical element.

FIG. 6 shows an example of the transmittances of the pixels of an optical element.

FIG. 7 shows an example of the brightness values of the pixels obtained by an image sensor.

FIG. 8 shows an example of the transmittances of the pixels of an adjusted optical element.

FIG. 9 shows another example of the transmittances of the pixels of a fine adjusted optical element.

### DETAILED DESCRIPTION OF SPECIFIC EMBODIMENTS

The following exemplary examples will be described in detail with the appended drawings in order to make the aforementioned objectives, functional features, and advantages more clearly understood.

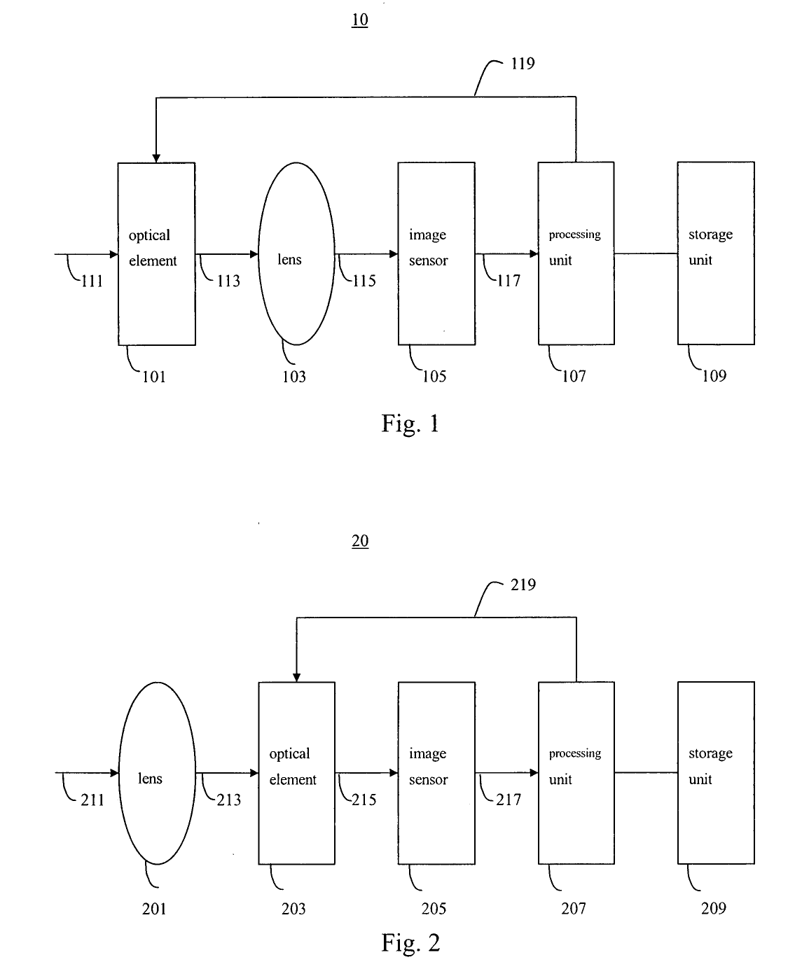

FIG. 1 shows an image-capturing system 10 according to a preferred embodiment of the present invention. The image-capturing system 10 includes an optical element 101, at least one lens 103, an image sensor 105, a processing unit 107, and a storage unit 109. The optical element defines a plurality of pixels of controllable transmittance for modulating a received image. The lens 103 focuses the modulated image. The image sensor 105 transforms the focused image into an electrical signal. The processing unit 107 outputs a control signal, in response to the electrical signal, to respectively control the transmittance of each pixel of the optical element 101. The storage unit is coupled with the processing unit 107 and stores the image information. In an exemplary embodiment, the optical element 101 is a liquid crystal panel. In another exemplary embodiment, the image sensor 105 includes a plurality of charge coupled devices (CCD) or a plurality of complementary metal-oxide semiconductors (CMOS). In another exemplary embodiment, the image-capturing system 10 is one of digital camera, digital video camera, or camera cellular phone.

In FIG. 1, the reference number 111 indicates an image of an object; the reference number 113 indicates an image modulated by the optical element 101; the reference number 115 indicates an image after being focused by the lens 103; the reference number 117 indicates an electrical signal transformed by the image sensor 105; the reference number 119 indicates a control signal outputted from the processing unit 107.

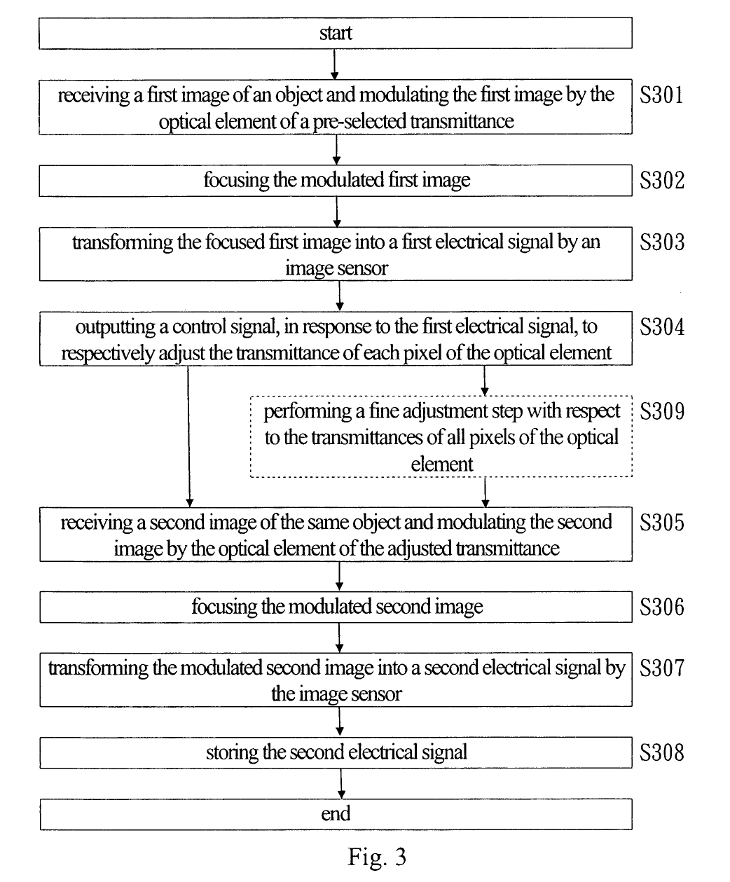

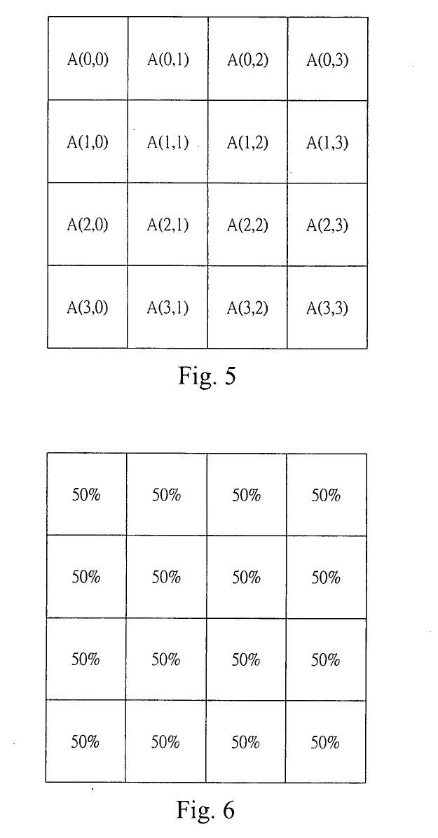

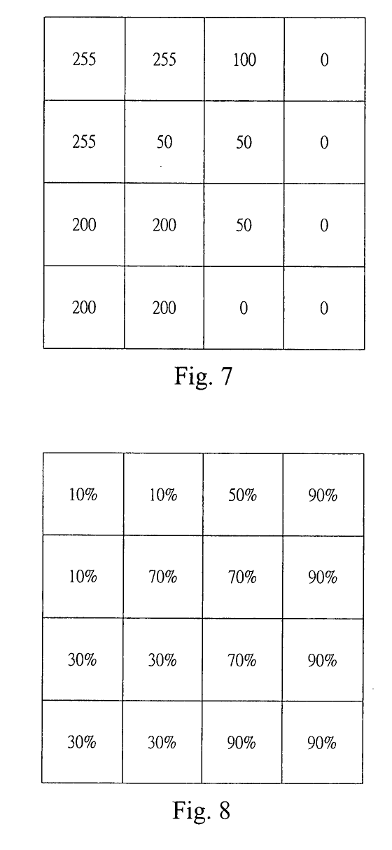

FIG. 3 shows a flow chart of an image-capturing method according to the above-mentioned image-capturing system 10. In step S301, the optical element 101 receives an image of an object and modulates the received image. More specifically, the image is modulated with the pre-selected transmittance of each pixel of the optical element 101. In step S302, the modulated image is focused onto the image sensor 105 by the lens 103. In step S303, the focused image is transformed into an electrical signal by the image sensor 105 and then sent to the processing unit 107. In step S304, the processing unit 107 outputs a control signal 119, in response to the electrical signal, to respectively adjust the transmittance of each pixel of the optical element 101. More specifically, the transmittance and the brightness values of pixels can be varied according to specific needs. For example, FIG. 5 shows an example of the pixels of an optical element 101. For a better understanding of the present invention, a 4×4 array is illustrated and each pixel is indicated by a matrix representation, such as pixel A(0,0), pixel A(1,0), and so on. As shown in FIG. 6, the transmittance of each pixel of the optical element 101 is preset to 50% of its maximum. With such transmittances of the optical element 101, an image of an object is modulated and then focused onto the image sensor 105 by a lens. For example, the brightness value of each pixel of the image received by the image sensor 105 is shown in FIG. 7, wherein “0” indicates the darkest, “255” indicates the brightest. By outputting the control signal 119 from the processing unit 107, the transmittances of the pixels (such as A(0,0), A(0,1), A(1,0)) with higher brightness value (such as 255) of the optical element 101 are adjusted to smaller transmittances (such as 10%) and the transmittances of the pixels (such as A(0,3), A(1,3), A(2,3), A(3,2), A(3,3)) with lower brightness value (such as 0) of the optical element 101 are adjusted to higher transmittances (such as 90%), as shown in FIG. 8. In an exemplary embodiment, the transmittances and the brightness values of pixel are in linear relationship. In another exemplary embodiment, the transmittances and the brightness values are in nonlinear relationship. It should be noticed that the spirit of the present invention is to adjust the transmittance of each pixel of an optical element by utilizing the analysis of the darker and brighter pixels of the image, so as to enhance the dynamic range of an image and to exhibit the details in bright and dark portions of the image. The actual algorithm to adjust the transmittances of the pixels can be determined based on specific needs.

In step S305, the optical element 101 receives an image of the same object and modulates the received image using the adjusted transmittances. In step S306, the modulated image is focused by the lens 103. Since the transmittances of the pixels with higher brightness value are adjusted to smaller transmittances and the transmittances of the pixels with lower brightness value are adjusted to higher transmittances, the resultant image has a wider dynamic range. In step S307, the focused image is transformed into an electrical signal by the image sensor 105. In step S308, the electrical signal is stored in the storage unit 109.

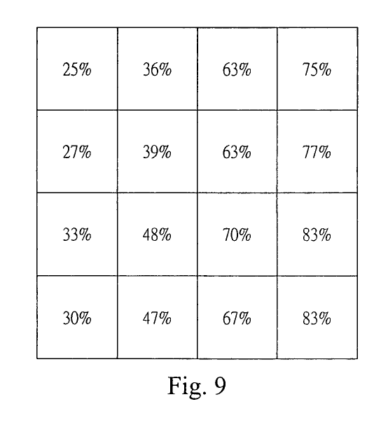

In another exemplary embodiment, between steps S304 and S305, the method further includes: performing a fine adjustment step S309 with respect to the transmittances of all pixels of the optical element 101. More specifically, after step S304, the transmittances of the pixels are adjusted to those as FIG. 8 shows, and after the fine adjustment step S309, the transmittances of the pixels are adjusted to those as FIG. 9 shows. The transmittances of FIG. 9 are calculated by the following method: the new transmittance of A(0,0), 25%, is obtained by summing up the transmittances of A(0,0), A(0,1), A(1,0), A(1, 1) and then dividing by four; the new transmittance of A(0,1), 36%, is obtained by summing up the transmittances of A(0,0), A(0,1), A(0,2), A(1,0), A(1,1), A(1,2) and then dividing by six; the new transmittance of A(0,2), 63%, is obtained by summing up the transmittances of A(0,1), A(0,2), A(0,3), A(1,1), A(1,2), A(1,3) and then dividing by six; the new transmittance of A(0,3), 75%, is obtained by summing up the transmittances of A(0,2), A(0,3), A(1,2), A(1,3) and then dividing by four; the new transmittance of A(1,0), 27%, is obtained by summing up the transmittances of A(0,0), A(0,1), A(1,0), A(1,1), A(2,0), A(2,1) and then dividing by six; the new transmittance of A(1,1), 39%, is obtained by summing up the transmittances of A(0,0), A(0,1), A(0,2), A(1,0), A(1,1), A(1,2), A(2,0), A(2,1), A(2,2) and then dividing by nine; the new transmittance of A(1,2), 63%, is obtained by summing up the transmittances of A(0,1), A(0,2), A(0,3), A(1,1), A(1,2), A(1,3), A(2,1), A(2,2), A(2,3) and then dividing by nine. With the same method, one easily obtains the new transmittance of 77% for A(1,3); the new transmittance of 33% for A(2,0); the new transmittance of 48% for A(2,1); the new transmittance of 70% for A(2,2); the new transmittance of 83% for A(2,3); the new transmittance of 30% for A(3,0); the new transmittance of 47% for A(3,1); the new transmittance of 67% for A(3,2); the new transmittance of 83% for A(3,3). It should be noticed that the spirit of the present invention is to efficiently exhibit the details in bright and dark portions of the image in a smoother way using the fine adjustment step S309.

FIG. 2 shows an image-capturing system 20 according to another preferred embodiment of the present invention. The difference between the image-capturing system 20 and image-capturing system 10 is the order of modulation and focusing. The image-capturing system 20 includes at least one lens 201, an optical element 203, an image sensor 205, a processing unit 207, and a storage unit 209. The lens 201 focuses a received image. The optical element 203 defines a plurality of pixels of controllable transmittance for modulating the focused image. The image sensor 205 transforms the modulated image into an electrical signal. The processing unit 207 outputs a control signal, in response to the electrical signal, to respectively control the transmittance of each pixel of the optical element 203. The storage unit 209 is coupled with the processing unit 207 and stores the image information. In an exemplary embodiment, the optical element 201 is a liquid crystal panel. In another exemplary embodiment, the image sensor 205 includes a plurality of charge coupled devices or a plurality of complementary metal-oxide semiconductors. In another exemplary embodiment, the image-capturing system 20 is one of digital camera, digital video camera, or camera cellular phone.

In FIG. 2, the reference number 211 indicates an image of an object; the reference number 213 indicates an image after being focused by the lens 203; the reference number 215 indicates an image modulated by the optical element 201; the reference number 217 indicates an electrical signal transformed by the image sensor 205; the reference number 219 indicates a control signal outputted from the processing unit 207.

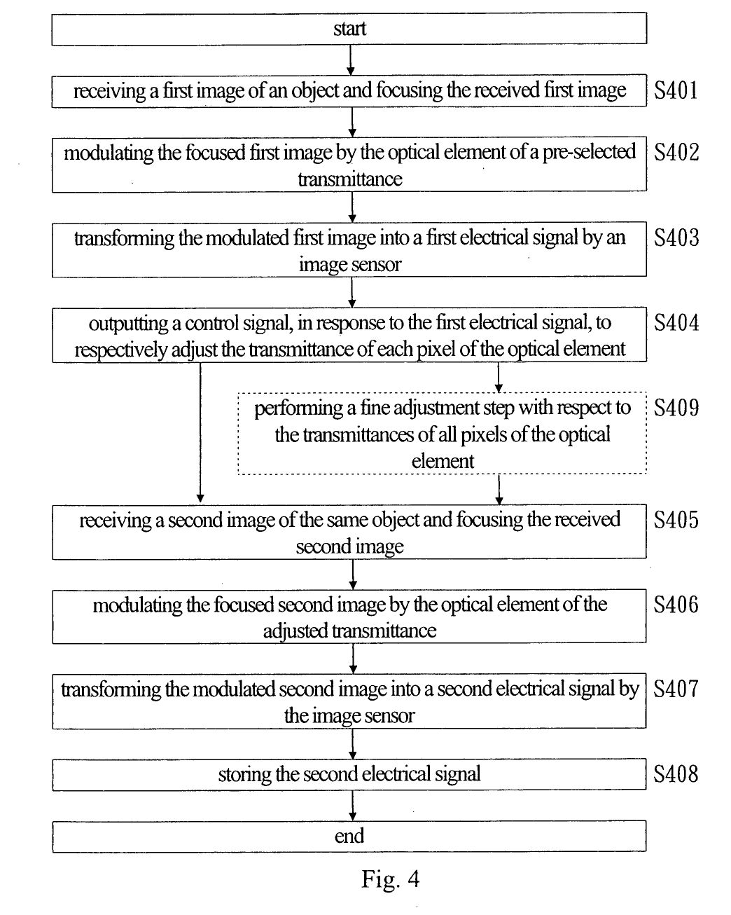

FIG. 4 shows a flow chart of an image-capturing method according to the above-mentioned image-capturing system 20. In step S401, the lens 201 receives an image of an object and focuses the received image onto the optical element 203. In step S402, the optical element 203 modulates the focused image. More specifically, the image is modulated with the pre-selected transmittance of each pixel of the optical element 203. In step S403, the modulated image is transformed into an electrical signal by the image sensor 205 and then sent to the processing unit 207. In step S404, the processing unit 207 outputs a control signal 219, in response to the electrical signal, to respectively adjust the transmittance of each pixel of the optical element 203. More specifically, the transmittance and the brightness values of pixels can be varied according to specific needs. The detail description regarding step S404 has been described above for step S304 and therefore omitted herein.

In step S405, the lens 201 receives an image of the same object and focuses the received image onto the optical element 203. In step S406, the focused image is modulated by the optical element 203 using the adjusted transmittances. Since the transmittances of the pixels with higher brightness value are adjusted to smaller transmittances and the transmittances of the pixels with lower brightness value are adjusted to higher transmittances, the resultant image has a wider dynamic range. In step S407, the modulated image is transformed into an electrical signal by the image sensor 205. In step S408, the electrical signal is stored in the storage unit 209.

In another exemplary embodiment, between steps S404 and S405, the method further includes: performing a fine adjustment step S409 with respect to the transmittances of all pixels of the optical element. The detail description has been described above for step S309 and therefore omitted herein.

While various exemplary embodiments of the present invention are described herein, it should be noted that the present invention may be embodied in other specific forms, including various modifications and improvements, without departing from the sprit and scope of the present invention. Thus, the described embodiments are to be considered in all respects only as illustrative and not restrictive.

What is claimed is:

1. An image-capturing system, comprising:
an optical element, defining a plurality of pixels of controllable transmittance for modulating a received image;
at least one lens for focusing the modulated image;
an image sensor for transforming the focused image into an electrical signal;
a processing unit for outputting a control signal, in response to the electrical signal, to respectively control the transmittance of each pixel of the optical element; and
a storage unit, coupled with the processing unit, for storing an image information.

2. An image-capturing system according to claim 1, wherein the optical element is a liquid crystal panel.

3. An image-capturing system according to claim 1, wherein the image sensor comprises a plurality of charge coupled devices (CCD) or a plurality of complementary metal-oxide semiconductors (CMOS).

4. An image-capturing system according to claim 1, wherein the image-capturing system is one of digital camera, digital video camera, or camera cellular phone.

5. An image-capturing system, comprising:
at least one lens for focusing a received image;
an optical element, defining a plurality of pixels of controllable transmittance for modulating the focused image;
an image sensor for transforming the modulated image into an electrical signal;
a processing unit for outputting a control signal, in response to the electrical signal, to respectively control the transmittance of each pixel of the optical element; and
a storage unit, coupled with the processing unit, for storing an image information.

6. An image-capturing system according to claim 5, wherein the optical element is a liquid crystal panel.

7. An image-capturing system according to claim 5, wherein the image sensor comprises a plurality of charge coupled devices or a plurality of complementary metal-oxide semiconductors.

8. An image-capturing system according to claim 5, wherein the image-capturing system is one of digital camera, digital video camera, or camera cellular phone.

9. An image-capturing method for an image-capturing system, the image-capturing system comprises an optical element, defining a plurality of pixels of controllable transmittance, comprising the steps of:
(a) receiving a first image of an object and modulating the first image by the optical element of a pre-selected transmittance;
(b) focusing the modulated first image;
(c) transforming the focused first image into a first electrical signal by an image sensor;
(d) outputting a control signal, in response to the first electrical signal, to respectively adjust the transmittance of each pixel of the optical element;
(e) receiving a second image of the same object and modulating the second image by the optical element of the adjusted transmittance;
(f) focusing the modulated second image;
(g) transforming the focused second image into a second electrical signal by the image sensor; and
(h) storing the second electrical signal.

10. An image-capturing method according to claim 9, between steps (d) and (e), further comprising:
performing a fine adjustment step with respect to the transmittances of all pixels of the optical element.

11. An image-capturing method according to claim 9, wherein in step (d), the control signal is determined based on analysis of the darkest and brightest pixels indicated by the first electrical signal.

12. An image-capturing method for an image-capturing system, the image-capturing system comprises an optical element defining a plurality of pixels of controllable transmittance, comprising the steps of:
(a) receiving a first image of an object and focusing the received first image;
(b) modulating the focused first image by the optical element of a pre-selected transmittance;
(c) transforming the modulated first image into a first electrical signal by an image sensor;
(d) outputting a control signal, in response to the first electrical signal, to respectively adjust the transmittance of each pixel of the optical element;
(e) receiving a second image of the same object and focusing the received second image;
(f) modulating the focused second image by the optical element of the adjusted transmittance;
(g) transforming the modulated second image into a second electrical signal by the image sensor; and (h) storing the second electrical signal.

13. An image-capturing method according to claim 12, between steps (d) and (e), further comprising:
performing a fine adjustment step with respect to the transmittances of all pixels of the optical element.

14. An image-capturing method according to claim 12, wherein in step (d), the control signal is determined based on analysis of the darkest and brightest pixels indicated by the first electrical signal.
